(19) United States
(12) Patent Application Publication
(10) Pub. No.: US 2019/0168921 A1
(43) Pub. Date: Jun. 6, 2019

(54) DOUBLE-STRACTURE BAG

(71) Applicants: Misaki KANDA, Saitama Pref. (JP); Daichi Yamashita, Tokyo (JP); Rika Miyoshi, Ibaraki Pref. (JP); Hiromichi Kitamura, Chiba Pref. (JP); Nene Hirai, Tokyo (JP); Seigo Hirayama, Saitama Pref. (JP); Ryo Onuki, Tokyo (JP); Satoko Kurisu, Tokyo (JP); Hiroya Hisaoka, Tokyo (JP)

(72) Inventors: Misaki KANDA, Saitama Pref. (JP); Daichi Yamashita, Tokyo (JP); Rika Miyoshi, Ibaraki Pref. (JP); Hiromichi Kitamura, Chiba Pref. (JP); Nene Hirai, Tokyo (JP); Seigo Hirayama, Saitama Pref. (JP); Ryo Onuki, Tokyo (JP); Satoko Kurisu, Tokyo (JP); Hiroya Hisaoka, Tokyo (JP)

(21) Appl. No.: 16/268,515

(22) Filed: Feb. 6, 2019

(51) Int. Cl. B65D 33/28; B65D 30/00; B65D 33/04; B65D 77/04; A47J 47/14

(52) U.S. Cl. CPC B65D 33/28; B65D 31/00; A47J 47/14; B65D 77/04; B65D 33/04

(57) ABSTRACT

A double structure bag includes an inner bag including a second food storage opening, wherein the inner bag includes a first and second bent portions located in an area adjacent to the second food storage opening, and wherein the first bent portion includes first openings at both side, and the second bent portion includes second openings at both side; an outer bag in which the inner bag is stored, having a first food storage opening, wherein the outer bag includes a tunnel, which having third openings at its both ends; and two elongated zipping members, each of which placed in one of the first and second bent portions, respectively, wherein both ends of each elongated zipping member are placed outside the outer bag by passing through the tunnel and by coming out from the third openings, respectively, whereby the second food storage opening is closed by pulling the elongated zipping members from the side to side, and wherein the elongated zipping members are tied together after area where the first food storage opening is formed is folded.

### BACKGROUND OF THE INVENTION

### 1. Field of the Invention

This invention has been made by the members of MIMURA Seminar, College of Law, Nihon, Univ. as a team. The present invention relates to a bag, in particular, to a double structure bag having an inner bag and an outer bag, which make it harder to leak the smell of contents therein.

### 2. Description of the Invention

When a product such as hamburgers or fries is purchased to go at a leading fast food restaurant, it was stored in a paper bag 300, which is illustrated in FIG. 4. Depending the products, some products have a strong smell, and the paper bag 300 often leaks the smell because of it's a thin structure. When it carried in the public transportation, the leakage of the smell may feel uncomfortable to the people around. In general, if it is focused only on the prevention for leaking smell of order, it is possible to resolve such a problem by using a bag having zipper at the location of its opening.

However, by using the bag with a zipper, there is another problem that it will not be easy to put the food in and out because of its zipper function. For these reasons, in order to put the food in to and out from the bag easily, the bag 300 is closed b folding itself at where the opening is located.

However, the closure of the opening be released by a small impact, and the opening of the bag 300 is re-opened easily and unexpectedly. Therefore, it is deficient as to the function for closing the opening of the bag. The present invention is to enable to solve the above problems.

### SUMMARY OF THE INVENTION

An objective of the present invention is to resolve the above described problem and to provide a double-structure bag having an outer bag and an inner bag. The objective is achieved by a double-structure bag including an inner bag including a second food storage opening, wherein the inner bag includes a first and second bent portions located in an area adjacent to the second food storage opening, and wherein the first bent portion includes first openings at both side, and the second bent portion includes second openings at both side; an outer bag in which the inner bag is stored, having a first food storage opening, wherein the outer bag includes a tunnel, which having third openings at its both ends; and two elongated zipping members, each of which is placed in one of the first and second bent portions, respectively, wherein both ends of each elongated zipping member are placed outside the outer bag by passing through the tunnel and by coming out from the third openings, respectively, whereby the second food storage opening is closed by pulling the elongated zipping members from the side to side, and wherein the elongated zipping members are tied together after area where the first food storage opening is formed is folded.

### BRIEF DESCRIPTION OF THE DRAWINGS

The invention will be more particularly described with reference to the accompanying drawings, in which:

FIG. 1 shows a perspective view of a double structure bag, according to the first preferred embodiments of the invention,

FIG. 2 shows a perspective view of an inner bag of the double structure bag illustrated in FIG. 1, and

FIG. 3 shows a perspective view of a double structure bag, according to the second preferred embodiments of the invention, and

FIG. 4 shows a paper bag of the related art.

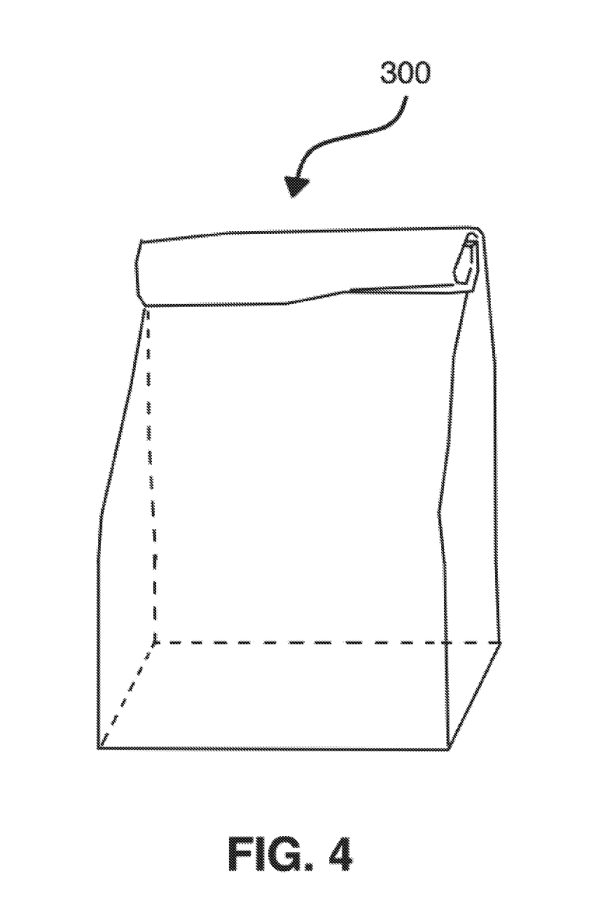

### DETAILED DESCRIPTION OF THE PREFERRED EMBODIMENTS

### The First Embodiment

The first preferred embodiment of the invention as to a writing equipment with scale attached is explained together with drawings as follows. In each drawing, the same reference numbers designate the same or similar components through all embodiments.

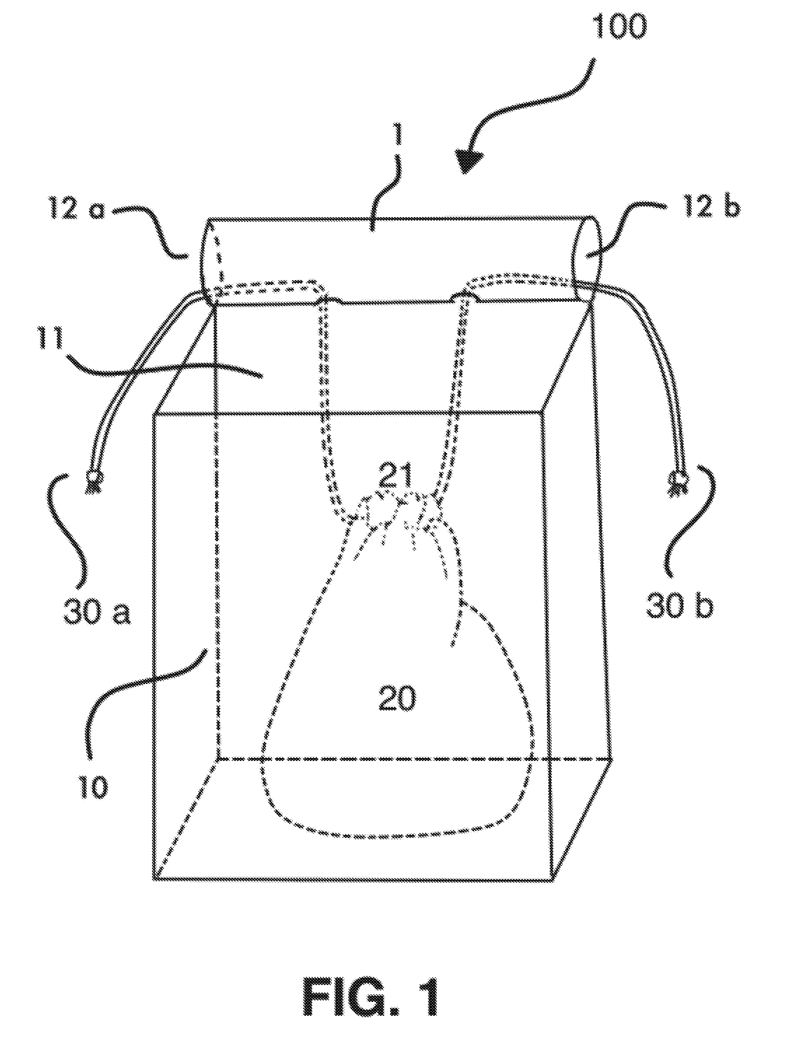

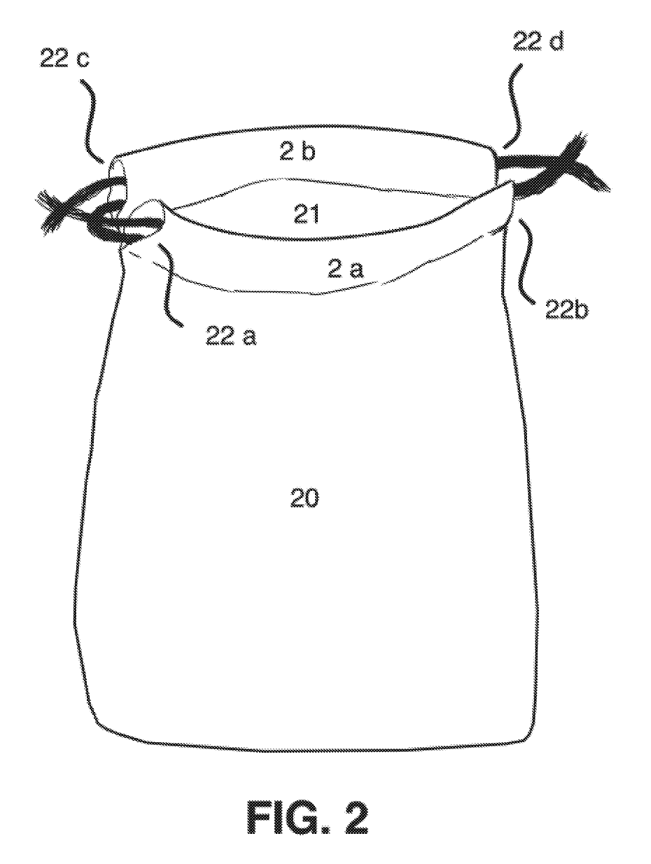

FIG. 1 shows a perspective view of a double structure bag 100. The double structure bag 100 includes an outer bag 10, an inner bag 20 and two elongated zipping members 30a and 30b. The outer bag 10 includes a first food storage openings 11 located on an upper side for putting foods, such as hamburgers and French Fries, in and out of, and a tunnel 1, which is formed along one side of the first opening 11. As shown in FIG. 2, the inner bag 20, which is located in the outer bag 10, includes a second food storage openings 21, a first bent portion 2a having first openings 22a and 22b at its ends and a second bent portion 2b having second openings 22c and 22d at its both side. According to the first embodiment, while the tunnel 1 includes two third openings 12a, 12b, the outer bag 10 itself includes two fourth openings 40a, 40b on the side surface thereof of the second embodiment, which is described below.

The double structure bag is used as follows. First, in a first embodiment, the one of the elongated zipping members 30a is placed in the first bent portion 2a by passing from the first opening 22a and to another first openings 22b, and then, the elongated zipping member 30a is placed in the second bent portion 2b by passing from the second opening 22d and to another second opening 22c. Another elongated zipping member 30b is placed in the second bent portion 2b passing in the opposite pathway, namely, by passing from the second opening 22d and to another second opening 22c, and then, the elongated zipping member 30b is placed in the first bent portion 2a by passing from the first opening 22a and to another first opening 22b.

Next, the both ends of the elongated zipping member 30a are placed outside of double structure bag 100 by passing through the tunnel 1 and by coming out from the third openings 12a, 12b, respectively. As well as the elongated zipping member 30a, the both ends of the elongated zipping member 30b are placed outside the double structure bag 100 by passing through the tunnel 1 and by coming out from the third openings 12a, 12b, respectively. Then, the area, where tunnel 1 is formed, is folded inwardly one or several times so that the first food storage opening 11 is closed lightly. Finally, the elongated zipping members 30a and 30b encompasses the outside of the folded first food storage opening 11, and the elongated zipping members 30a and 30b are tied together on the surface which is opposite to folded one.

Then, after the content, such as foods, is placed in the inner bag 20, the second food storage openings 21 is closed by pulling both ends of the elongated zipping members 30a and 30b. According to the structure described above, since the zipping members 30a and 30b are tied on the location as described above, the zipping members 30a and 30b can maintain the state against the force, which returns the folded area to the pre-folded location, and it can also maintain the folded state even the impact is applied to the double structure bag 100 from the outside. In addition, the prevention of the leakage of the smell the inner bag 20 can be expected.

### The Second Embodiment

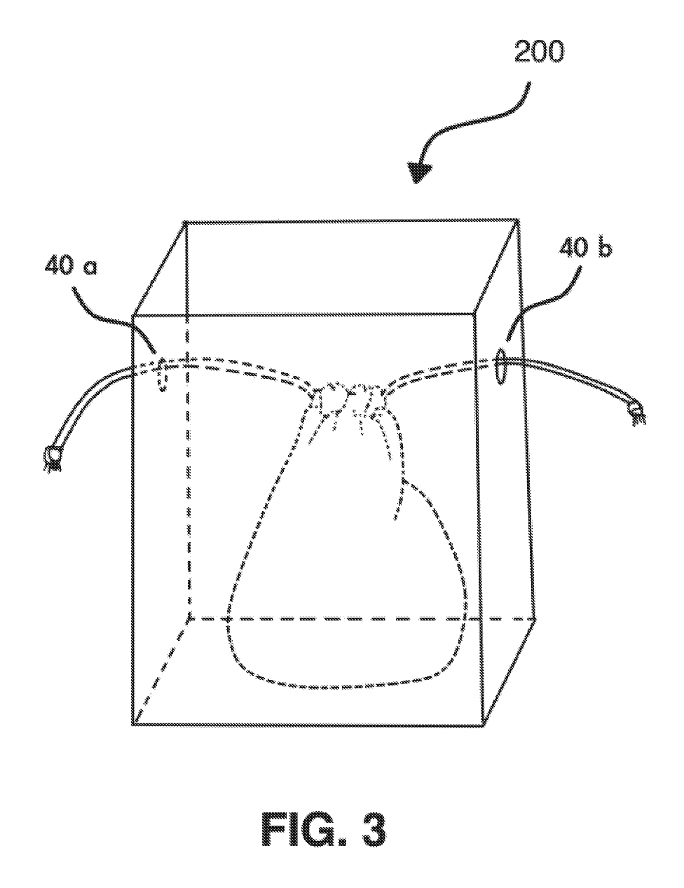

As well as the first embodiment, a double structure bag 200 of the second embodiment includes an outer bag 10, an inner bag 20 and two elongated zipping members 30a and 30b. As shown in FIG. 3, the outer bag 10 of the second embodiment includes the fourth openings 40a, 40b, each of which is formed on its side surface, respectively, as described above.

In the second embodiment, as well as the first embodiment, the zipping member 30a is placed in the second tunnel 2a by passing from the first opening 22a and to another first opening 22b, and then, the zipping members 30a is placed in the third tunnel 2b by passing from the second opening 22d and to another second opening 22c. Another zipping member 30b is placed in the third tunnel 2b by passing in the opposite pathway, namely, by passing from the second opening 22d and to another second opening 22c, and then, the zipping member 30b is placed in the second tunnel 2a by passing from the first opening 22a and to another first opening 22b. Then, after the content, such as food, is placed in the inner bag 20, the second food storage opening 21 is closed by pulling both ends of the zipping members 30a and 30b.

Then, the inner bag 20 is placed in the outer bag 10. Next, each of the elongated zipping members 30a, 30b passes through one of the fourth openings 40a, 40b, respectively, and area where the opening 11 is formed is bent and closed. Thereafter, by tying the elongated zipping members 30a, 30b, it is expected that the contents can hardly jump out from the inner bag 20.

In a first and a second embodiments, while the material of the outer bag 10 is paper, the material of the inner bag 20 is primarily aluminum or polyethylene. However, it is not necessary to limited to the above mentioned material. Further, paper, cotton, metal, vinyl and synthetic resin can be used for them. Moreover, the elongated zipping members 30a, 30b may be made of metal primarily, but other material such as paper, cotton, wire, polyethylene and synthetic resin can be used for them.

According to a first embodiment, since the plurality of openings, such as the first openings 22a, 22b and the second openings 22c, 22d, are formed in the inner bag 20, the durability may be is less than the other parts. Therefore, the area in which the first openings 22a, 22b and the second openings 22c, 22d are formed may be formed slightly thick. Similarly, according to a second embodiment, the first area in which the fourth openings 40a and 40b are formed slightly thicker than other area for the same reason.

While the invention has been described with reference to illustrative embodiments, this description is not intended to be construed in a limiting sense. Thus, shapes, size and physical relationship of each component are roughly illustrated so the scope of the invention should not be construed to be limited to them. Further, to clarify the components of the invention, hatching is partially omitted in the cross-sectional views. Moreover, the numerical description in the embodiment described above is one of the preferred examples in the preferred embodiment so that the scope of the invention should not be construed to limit to them.

Various other modifications of the illustrated embodiment will be apparent to those skilled in the art on reference to this description. Therefore, the appended claims are intended to cover any such modifications or embodiments as fall within the true scone of the invention.

We claim:

1. A double structure bag comprising:
an inner bag including a second food storage opening, wherein the inner bag includes a first and second bent portions located in an area adjacent to the second food storage opening, and wherein the first bent portion includes first openings at both side, and the second bent portion includes second openings at both side;
an outer bag in which the inner bag is stored, having a first food storage opening, wherein the outer bag includes a tunnel, which having third openings at its both ends; and
two elongated zipping members, each of which is placed in one of the first and second bent portions, respectively,
wherein both ends of each elongated zipping member are placed outside the outer bag by passing through the tunnel and by coming out from the third openings, respectively,
whereby the second food storage opening is closed by pulling the elongated zipping members from the side to side, and
wherein the elongated zipping members are tied together after area where the first food storage opening is formed is folded.

2. A double structure bag as claimed in claim 1, wherein the outer bag is made of paper.

3. A double structure bag as claimed in claim 2, wherein the inner bag is made of aluminum.

4. A double structure bag as claimed in claim 3, wherein the elongated zipping members are made of cotton.

5. A double structure bag as claimed in claim 3, the elongated zipping members are made of wire.

6. A double structure bag as claimed in claim 2, wherein the inner bag is made of vinyl.

7. A double structure bag as claimed in claim 6, wherein the elongated zipping members are made by cotton.

8. A double structure bag as claimed in claim 6, the elongated zipping members are made of wire.

9. A double structure bag comprising:
an inner bag including a second food storage opening, wherein the inner bag includes a first and second bent portions located in an area adjacent to the second food storage opening, and wherein the first bent portion includes first openings at both side, and the second bent portion includes second openings at both side;
an outer bag in which the inner bag is stored, having a first food storage opening, and two side surfaces facing to each other, wherein the outer bag includes two fourth openings, each of which is formed in the side surface, respectively, and
two elongated zipping members, each of which is placed in in one of the first and second bent portions, respectively,
wherein both ends of each elongated zipping members are placed outside the outer bag by passing through one of the fourth openings, respectively,
whereby the second food storage openings are closed by pulling the two elongated zipping members from the side to side, and
wherein the two elongated zipping members are tied together after the area where the first food storage opening formed is folded.

10. A double structure bag as claimed in claim 2, wherein the elongated zipping members are made of synthetic resin.

11. A double structure bag as claimed in claim 10, wherein the elongated zipping members are made of paper.

12. A double structure bag as claimed in claim 11, wherein the inner bag is made of paper.

13. A double structure bag as claimed in claim 3, wherein the elongated zipping members are made by synthetic resin.

14. A double structure bag as claimed in claim 13, the elongated zipping members are made of cotton.

15. A double structure bag as claimed in claim 14, wherein the inner bag is made of cotton.

16. A double structure bag as claimed in claim 14, the elongated zipping members are made of wire.
